(19) United States
(12) Patent Application Publication
(10) Pub. No.: US 2013/0069277 A1
(43) Pub. Date: Mar. 21, 2013

(54) RESIN COMPOSITION SHEET AND METHOD FOR MOLDING THEREOF

(71) Applicants: Tetsuya Nakaniwa, Tokyo (JP); Takahiro Fujimoto, Tokyo (JP); Masahiko Watanabe, Tokyo (JP)

(72) Inventors: Tetsuya Nakaniwa, Tokyo (JP); Takahiro Fujimoto, Tokyo (JP); Masahiko Watanabe, Tokyo (JP)

(73) Assignee: SUMITOMO BAKELITE CO., LTD., Shinagawa-ku, Tokyo (JP)

(21) Appl. No.: 13/634,702

(22) PCT Filed: Mar. 14, 2011
(86) PCT No.: PCT/JP2011/001476

§ 371 Date: Sep. 13, 2012

(30) Foreign Application Priority Data
Mar. 16, 2010 (JP) 2010-058894

(51) Int. Cl. C08L 69/00; C08L 67/02; B29C 35/02

(52) U.S. Cl. CPC C08L 69/00; B29C 35/02; C08L 67/02
USPC 264/299; 524/537

(57) ABSTRACT

The object of the present invention is to provide a resin composition sheet that when used in the manufacture of product packaging such as carrier tapes, and the like, molding temperatures can be lowered from 260-280° C. to 200-250° C., even when heated to relatively high temperatures using a contact heating device with a mold-releasing film interposed therebetween, wherein poor appearance due to the replication of mold-releasing film features is unlikely to occur. The resin composition sheet relating to one aspect of the present invention comprises polycarbonate resin, amorphous polyester resin, and silicate compound filler. Furthermore, this resin composition sheet is suitable for use in the manufacture of product packaging such as carrier tapes, and the like. Furthermore, when an object that is vulnerable to static electricity is to be accommodated within product packaging, it is preferable to add a conductive filler to prevent the static charge in the accommodated product.

### TECHNICAL FIELD

The present invention relates to a resin composition sheet. Moreover, the present invention relates to a method for molding a resin composition sheet.

### BACKGROUND ART

A “sheet material formed from a blend obtained by blending amorphous polyester resin with polycarbonate resin” has been proposed in the past (for example, see Japanese Unexamined Patent Publication No. 2004-91691). Thus, such a sheet material can serve in the manufacture of product packaging such as carrier tapes, and the like. their molding temperatures can be lowered from 260-280° C. to 200-250° C., and the users of such sheet materials can contribute to reducing energy expenditures.

### PRIOR ART LITERATURE

### Patent Literature

Patent Document 1: Japanese Unexamined Patent Publication No. 2004-91691

### SUMMARY OF THE INVENTION

### Problem to be Solved by the Invention

However, when such sheet materials are heated to temperatures in the vicinity of 200-250° C. using a contact type heating device, the shape of the mold-releasing film (e.g., Teflon®) that is mounted on a heating platen of the contact heating device can give rise to a poor appearance being transferred to the sheet materials.

For this problem, it is believed that the countermeasure is due to the preset temperature for the heating platen being relatively low, which by itself is frequently the reason why sufficient precise molding is not obtained.

The object of the present invention is to provide a resin composition sheet that when used in the manufacture of product packaging such as carrier tapes, and the like. the molding temperatures can be lowered from 260-280° C. to 200-250° C., even when heated to relatively high temperatures using a contact heating device through a mold-releasing film, and poor appearance due to the replication of features of the mold-releasing film is unlikely to occur.

### Means to Solve the Problem

(1)

The resin composition sheet relating to one aspect of the present invention comprises polycarbonate resin, amorphous polyester resin, and silicate compound filler.

When the resin composition sheet as described above, when it is supplied for the manufacture of product packaging such as carrier tapes, and the like, the molding temperature can be lowered from 260-280° C. to 200-250° C., even when heated to relatively high temperatures using a contact heating device through a mold-releasing film, and poor appearance due to the replication of features of the mold-releasing film is unlikely to occur.

(2)

In the resin composition sheet relating to the aspect in (1) above, a silicate compound filler is preferably added as 1 part by weight or more and 3 parts by weight or less when the total amount of polycarbonate resin and amorphous polyester resin is taken as 100 parts by weight.

With the abovedescribed amount of silicate compound filler added, even when heated to relatively high temperatures using a contact heating device through a mold-releasing film, along with making poor appearance due to the replication of features of the mold-releasing film is unlikely to occur. good appearance of product packing such as carrier tapes and the like can be maintained, and furthermore good flexibility of product packaging such as carrier tapes and the like can be maintained.

(3)

In the resin composition sheet relating to the aspects in (1) or (2) above, polycarbonate resin is preferably added as 30 parts by weight or more and 80 parts by weight or less when the total amount of polycarbonate resin and amorphous polyester resin is taken as 100 parts by weight.

When the amount of polycarbonate resin added is as described above product packaging such as carrier tapes, and the like, obtained from the resin composition sheet satisfactorily meet the required physical properties.

(4)

In the resin composition sheet relating to the aspects in any of (1) through (3) above, the amorphous polyester resin is preferably composed of at least 1 type of dicarboxylic acid-derived unit selected from the group comprising terephthalic acid-derived units and terephthalic acid derivative-derived units, and glycol-derived units including less than 50 mol % of 1,4-cyclohexanedimethanol-derived units.

With the amorphous polyester resin as described above; product packaging such as carrier tapes, and the like, obtained from the resin composition sheet will exhibit superior physical properties.

(5)

In the resin composition sheet relating to the aspects in any of (1) through (3) above, the amorphous polyester resin is preferably composed of at least 1 type of dicarboxylic acid-derived unit selected from the group comprising terephthalic acid-derived units and terephthalic acid derivative-derived units, and glycol-derived units including less than 50 mol % of 1,4-cyclohexanedimethanol-derived units.

With the amorphous polyester resin as described above, product packaging such as carrier tapes, and the like, obtained from the resin composition sheet will exhibit superior physical properties.

(6)

The resin composition sheet relating to the aspects in any of (1) through (6) above further preferably contains conductive carbon black. However, the absorbed oil content of this conductive carbon black is 130 cm³/100 g or more, and the pH is 8 or higher. Furthermore, this conductive carbon black is present in the resin composition sheet in the condition of being dispersed in a blend of the polycarbonate resin and amorphous polyester resin. In addition, the absorbed oil content of this conductive carbon black in the present invention is the absorbed oil content of dibutyl phthalate (DBP) as measured according to JIS K6221, JIS K6217, or ASTM D2414, or the absorbed oil content of paraffin oil as measured according to ASTM D2414. Additionally, in the present invention, the pH of the conductive carbon black can be obtained by measurement of a mixture solution of conductive carbon black and distilled water using a glass electrode pH meter.

The carbon black having the abovementioned physical properties is dispersed within the resin composition sheet, which not only can impart electrical conductivity to the resin composition sheet, but can lower the moisture content of the resin composition sheet, and the product packaging will have a good appearance when the resin composition sheet is supplied for the manufacture of product packaging such as carrier tapes, and the like.

(7)

In the resin composition sheet relating to aspect (6) above, the conductive carbon black preferably has a volatile portion of 0.3 wt % or less. Furthermore, in the present invention, the volatile portion of the conductive carbon black can be obtained from the reduction in weight measured when the conductive carbon black is heated to 950° C. for 7 minutes.

The carbon black having the abovementioned physical properties is dispersed within the resin composition sheet, which not only can impart electrical conductivity to the resin composition sheet, but can lower the moisture content of the resin composition sheet, and when the resin composition sheet is supplied for the manufacture of product packaging such as carrier tapes, and the like, and the product packaging will have a good appearance because the formation of blisters in the resin sheet surface can be reduced.

(8)

In the resin composition sheet relating to the aspects in (6) or (7) above, conductive carbon black is preferably added as 5 parts by weight or more and 25 parts by weight or less when the total amount of polycarbonate resin and amorphous polyester resin is taken as 100 parts by weight.

Addition of the abovementioned amount of the conductive carbon black having the abovementioned physical properties imparts good conductivity to the resin composition sheet without substantially impairing the mechanical properties thereof.

(9)

A method for molding the resin composition sheet relating to another aspect of the present invention includes a heating step and a molding step. In the heating step, the abovementioned resin composition sheet is heated through contact with a heating medium having a mold releasing film interposed therebetween. In the molding step, the resin composition sheet that was heated in the heating step is molded into a predetermined shape. Furthermore, when the resin composition sheet is molded into a carrier tape, the resin composition sheet is molded into a concave shape in the molding step.

As mentioned above, along with lowering the molding temperature from 260-280° C. to 200-250° C. in the molding method for this resin composition sheet, it is unlikely that replication of mold-releasing film features on the resin composition sheet will occur.

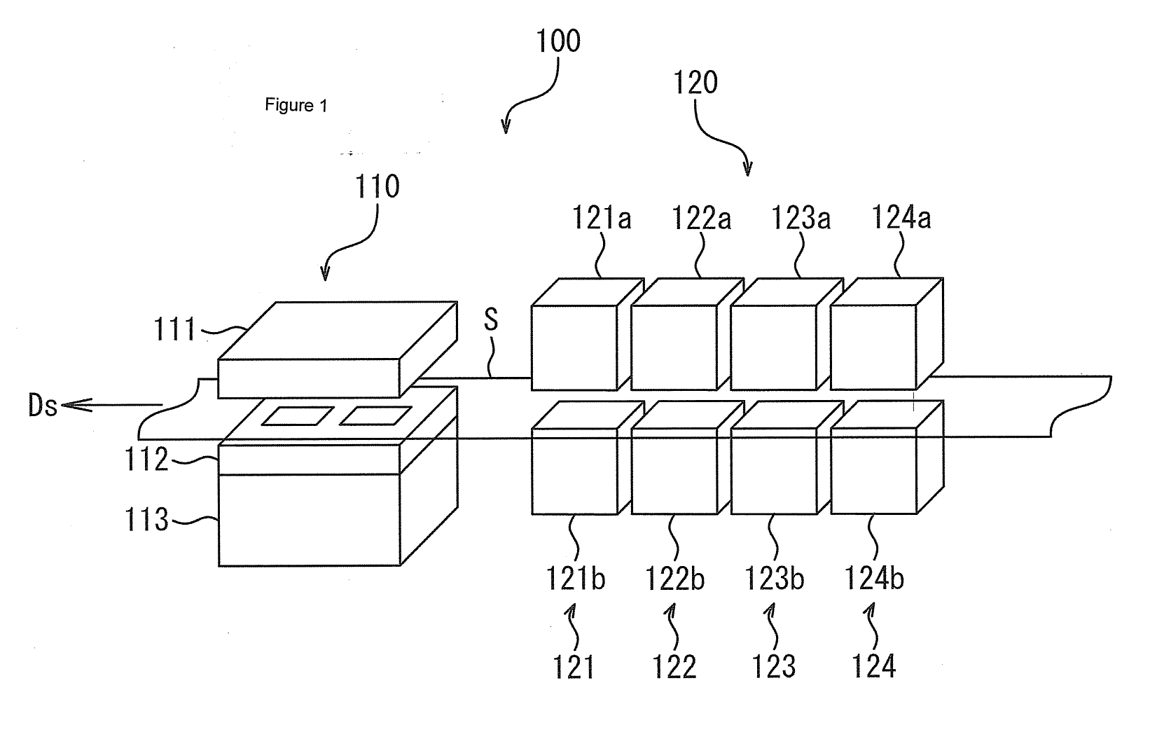

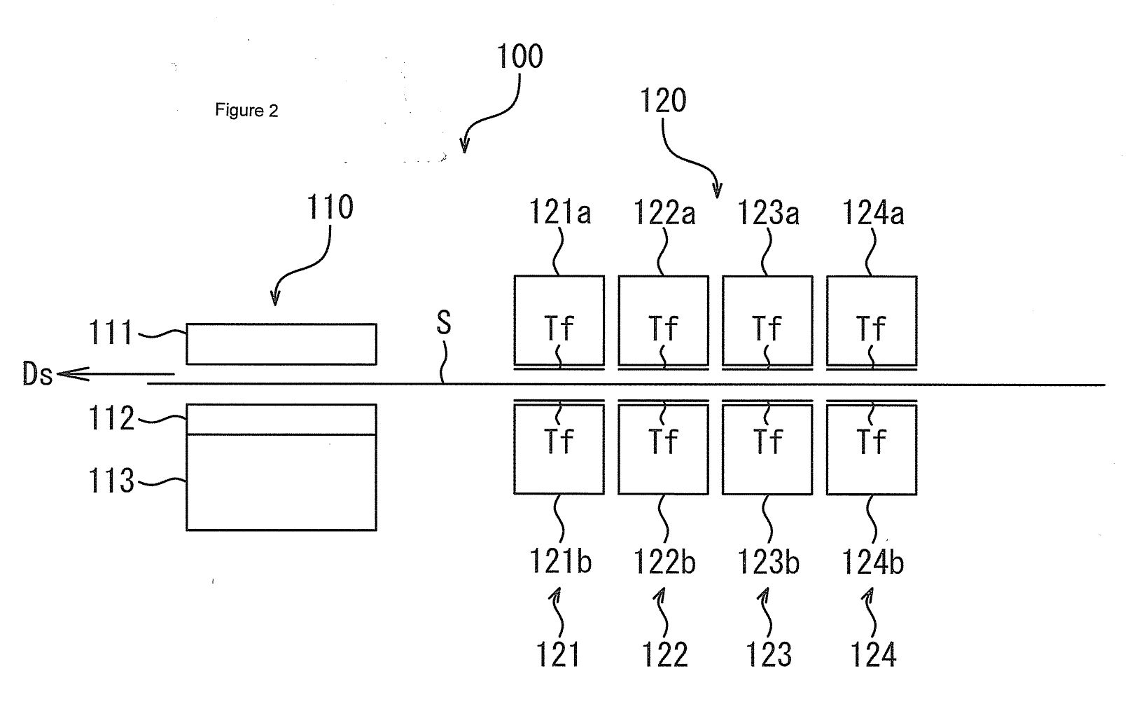

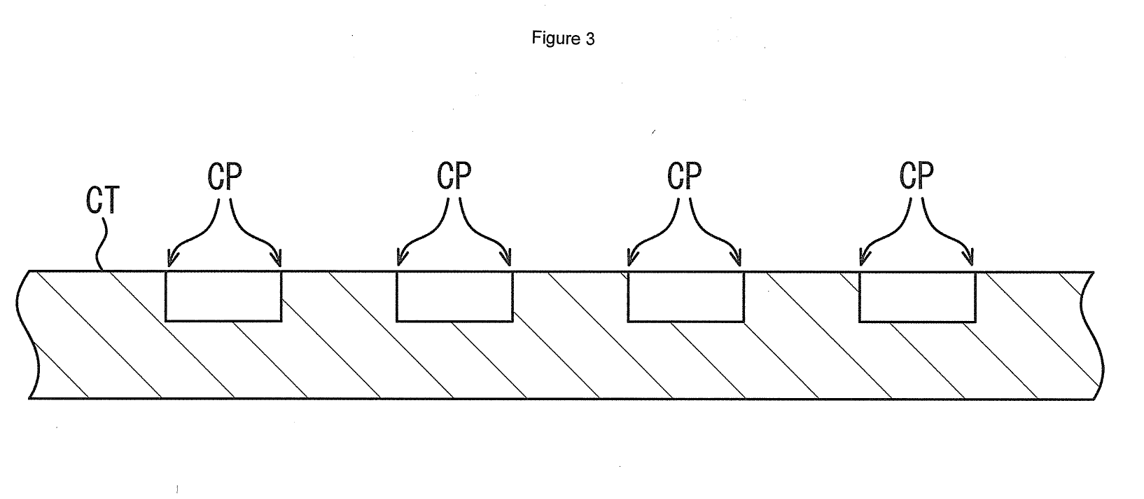

### BRIEF EXPLANATION OF DIAGRAMS

[FIG. 1] A schematic perspective diagram of a carrier tape manufacturing device according to one embodiment of the present invention.

[FIG. 2] A schematic side-view diagram of a carrier tape manufacturing device according to one embodiment of the present invention.

[FIG. 3] A diagram showing the angular component at the locations of applied flexural stress during a evaluation of the flexibility of a carrier tape relating to Working Example 1

### EXPLANATION OF SYMBOLS

100 Device for manufacturing carrier tape
110 Vacuum forming device
111 Movable molding device
112 Fixed molding device
113 Decompression device
120 Contact heater device
121-124 Heating platen device
121a-124a Movable heating platen
121b-124b Fixed heating platen
Ds Resin composition sheet feed direction

### MODES FOR IMPLEMENTING THE INVENTION

The resin composition sheet relating to an embodiment of the present invention for use in the manufacture of product packaging such as carrier tapes, and the like, is chiefly constituted from polycarbonate resin, amorphous polyester resin, and silicate compound filler (this resin composition sheet can also be said to be molded from a blend of polycarbonate resin and amorphous polyester resin to which a silicate compound filler has been added).

Furthermore, when this resin composition sheet is used to manufacture for “product packaging to accommodate an object that is vulnerable to static electricity” such as carrier tapes, and the like, it is preferable to further add a conductive filler. Moreover, in such a case, it is preferable for the surface resistivity of the resin composition sheet to be 10² to 10¹²Ω.

The ingredients that constitute the resin composition sheet are explained in detail below.

### <Resin Composition Sheet Ingredients>

(1) Polycarbonate Resin

Examples of polycarbonate resin include aromatic polycarbonate resins, aliphatic polycarbonate resins, aromatic-aliphatic polycarbonate resins, and the like. Furthermore, aromatic polycarbonate resins are preferred in the present embodiment. In addition, the polycarbonate resin in the present embodiment can be a single type of polycarbonate resin, and can also be a blend of multiple types of polycarbonate resin.

Aromatic polycarbonate resins are derived from aromatic dihydroxy compounds.

Examples of aromatic dihydroxy compounds include bis(hydroxyaryl)alkanes such as 1,1-bis(4-hydroxy-t-butylphenyl)propane, 2,2-bis(4-hydroxyphenyl)propane, and the like; bis(hydroxyaryl)cycloalkanes such as 1,1-bis(4-hydroxyphenyl)cyclopentane, 1,1-bis(4-hydroxyphenyl)cyclohexane, and the like; dihydroxyaryl ethers such as 4,4′-dihydroxydiphenyl ether, 4,4′-dihydroxy-3,3′-dimethylphenyl ether, and the like; dihydroxyaryl sulfides such as 4,4′-dihydroxydiphenyl sulfide, 4,4′-dihydroxy-3,3′-dimethylphenyl sulfide, and the like; dihydroxyaryl sulfoxides such as 4,4′-dihydroxydiphenyl sulfoxide, 4,4′-dihydroxy-3,3′-dimethylphenyl sulfoxide, and the like; dihydroxyaryl sulfones such as 4,4′-dihydroxydiphenyl sulfone, 4,4′-dihydroxy-3,3′-dimethylphenyl sulfone, and the like.

Furthermore, among such aromatic dihydroxy compounds, 2,2-bis(4-hydroxyphenyl)propane (common name, bisphenol A) are particularly preferred. Such aromatic dihydroxy compounds can also be used singly, or in combinations of two or more types.

Furthermore, aromatic polycarbonate resins can be manufactured by known methods for are, for example, the method in which an aromatic dihydroxy compound and a carbonate precursor are caused to react, for example, when an aromatic dihydroxy compound and a carbonate precursor (for example, phosgene) are caused to react by an interfacial polymerization method (for example, phosgene method) in the presence of an aqueous sodium hydroxide solution and methylene chloride as solvent, or an aromatic dihydroxy compound and a carbonate diester (for example, diphenyl carbonate) or the like are caused to react by an ester exchange method (for example, the fusion method), or by the solid phase polymerization method (Japanese Unexamined Patent Publication No. H01-158033, Japanese Unexamined Patent Publication No. H01-271426, Japanese Unexamined Patent Publication No. H03-68627) or the like applied to crystalline carbonate prepolymers obtained by the phosgene method or the fusion method.

(2) Amorphous Polyester Resin

Examples of amorphous polyester resins include amorphous polyester resins (PETG) constituted from at least one type of dicarboxylic acid-derived units selected from the group comprising terephthalic acid-derived units and terephthalic acid derivative-derived units, and glycol-derived units containing less than 50 mol % of 1,4-cyclohexanedimethanol-derived units, or amorphous polyester resins (PCTG) constituted from at least one type of dicarboxylic acid-derived units selected from the group comprising terephthalic acid-derived units and terephthalic acid derivative-derived units, and glycol-derived units containing 50 mol % or more of 1,4-cyclohexanedimethanol-derived units, or the like

Furthermore, within the scope that is not detrimental to the essence of the present invention, the dicarboxylic acid-derived units of the abovementioned amorphous polyester resins can include isophthalic acid-derived units, naphthalenedicarboxylic acid-derived units, diphenyldicarboxylic acid-derived units, adipic acid-derived units, sebacic acid-derived units, trimesic acid-derived units, trimellitic acid-derived units, and the like.

Examples of glycol-derived units in the abovementioned amorphous polyester resin other than 1,4-cyclohexanedimethanol-derived units include ethylene glycol-derived units, propylene glycol-derived units, tetramethylene glycol-derived units, and hexamethylene glycol-derived units.

Furthermore, in the present embodiment, when the total amount of polycarbonate resin and amorphous polyester resin is taken as 100 parts by weight, the amount of added amorphous polyester resin is preferable 20 parts by weight or more and 90 parts by weight or less, more preferably 30 parts by weight or more and 80 parts by weight or less, and further preferably 40 parts by weight or more and 70 parts by weight or less.

(3) Silicate Compound Filler

Concrete examples of silicate compound fillers include talc, mica, wollastonite, xonotlite, kaolin clay, montmorillonite, bentonite, sepiolite, imogolite, sericite, lawsonite, smectite, and the like. Furthermore, the silicate compound filler can be a natural substance, an artificial substance, or a mixture of natural and artificial substances. Additionally, among the abovementioned silicate compound fillers, talc and mica are the most preferred. Moreover, such silicate compound fillers can also be used singly, or in combinations of two or more types.

Any desired form (plate form, needle form, granular form, fiber form, and the like) of this silicate compound filler can be used, but the plate form and needle form are preferred, and the plate form is further preferred.

The average particle diameter for the silicate compound filler is preferably 0.1-500 μm, more preferably 0.5-100 μm, furthermore preferably 1-50 μm, still further preferably 2-30 μm, and yet further preferably 3-20 μm.

When the total amount of polycarbonate resin and amorphous polyester resin is taken as 100 parts by weight, the amount of silicate compound filler added in the present embodiment is preferably 1 part by weight or more and 3 parts by weight or less, and more preferably 1.5 parts by weight or more and 2.5 parts by weight or less.

(4) Conductive Filler

Examples of conductive filler include carbon black, carbon fiber, and the like. Examples of carbon black include furnace black, channel black, ketjen black, acetylene black, and the like. Examples of furnace black include Ensaco 250G (Timcal, absorbed oil content: 190 cm³/100 g; pH: 8-11; volatile content: max 0.2 wt %), 3400B (Mitsubishi Chemical Corp., DBP absorbed oil content: 175 cm³/100 g; pH: 6.2; volatile content: 1.0 wt %), 3050B (Mitsubishi Chemical Corp., DBP absorbed oil content: 175 cm³/100 g; pH: 7.0; volatile content: 0.5 wt %), #4500 (Tokai Carbon Co., DBP absorbed oil content: 168 cm³/100 g; pH: 6.0; volatile content: 0.6 wt %), #5500 (Tokai Carbon Co., DBP absorbed oil content: 155 cm³/100 g; pH: 6.0; volatile content: 1.4 wt %), along with F200 (Asahi Carbon Co., DBP absorbed oil content: 180 cm³/100 g; pH: 6.5; volatile content: 0.7 wt %), and AX-015 (Asahi Carbon Co., DBP absorbed oil content: 147 cm³/100 g; pH: 6.5; volatile content: 1.5 wt %), and the like. Examples of ketjen black include Ketjen Black EC (Ketjen Black International, DBP absorbed oil content: 360 cm³/100 g; pH: 9.0; volatile content: 0.5 wt %), and the like. Examples of acetylene black include Denka Black (Denki Kagaku Kogyo Kabusiki Kaisha, DBP absorbed oil content: 160 cm³/100 g; pH: 9-10; volatile content: 0.16 wt %), and the like. Furthermore, among the foregoing, particularly preferred are carbon blacks with a DBP absorbed oil content of 130 cm³/100 g or higher, and a pH of 8 or higher, corresponding to Denka Black (Denki Kagaku Kogyo), Ketjen Black EC (Ketjen Black International), and Ensaco 250G (Timcal) among the abovementioned commercial products.

Due to the above physical properties and sufficiently low moisture content, a special drying heat treatment is unnecessary for such carbon blacks.

Moreover, among the abovementioned carbon blacks, those with a volatile content of 0.3 wt % or less (corresponding to Denka Black (Denki Kagaku Kogyo Kabusiki Kaisha) and Ensaco 250G (Timcal) among the abovementioned commercial products) are further preferred. Furthermore, in the present application, the DBP absorbed oil content is measured according to JIS K6221, JIS K6217, or ASTM D2412, the paraffin oil absorbed oil content is measured according to ASTM D2412, the pH is measurement is obtained using a pH meter on a mixture solution of conductive carbon black and distilled water, and the volatile content is measured from the reduction in weight when the conductive carbon black is subjected to 7 minutes of heat treatment at 950° C. In addition, it is preferable for the carbon black to have been sufficiently dried before being added to the blend of polycarbonate and amorphous polyester resin.

In the present embodiment, when the total amount of polycarbonate resin and amorphous polyester resin is taken as 100 parts by weight, the amount of added conductive carbon black is preferable 5 parts by weight or more and 50 parts by weight or less, more preferably 5 parts by weight or more and 25 parts by weight or less, and further preferably 8 parts by weight or more and 20 parts by weight or less.

(5) Other Components

Depending on the requirements, components other than those mentioned above can be added to the resin composition sheet relating to the present embodiment, for example flame retardant agents, antidripping agents, dyes and pigments, heat stabilizing agents, ultraviolet radiation absorbing agents, fluorescent whitening agents, lubricants, plasticizers, processing aids, dispersing agents, mold-releasing agents, thickening agents, antioxidant antistatic agents and the like.

<Resin Composition Sheet Manufacturing Method>

All or a portion of the abovementioned components can be placed in a pre-mixing device such as a Banbury mixer, tumbler, ribbon blender, supermixer, or the like, and after kneading and pelletizing using a weight feeder with a melt-mixing kneading device such as a monoaxial extruder or biaxial extruder, ko-kneader, or the like, the resin composition sheet relating to an embodiment of the present invention can be manufactured by known methods, for example using extrusion molding, calendar molding, or the like.

<Carrier Tape Manufacturing Method>

After softening by heating by the abovementioned heating device of the abovementioned resin composition sheet using a contact heating device, the carrier tape from an embodiment of the present invention can be manufactured employing known molding methods such as vacuum forming, press forming, pressure forming, plug assist molding, and the like.

Furthermore, an example of a carrier tape manufacturing device is shown in FIGS. 1 and 2. This carrier tape manufacturing device 100 is described below.

Carrier tape manufacturing device 100 is chiefly constituted from contact heating device 120 and vacuum forming device 110. Furthermore, contact heating device 120 is arranged to be upstream in the feed direction Ds of the resin composition sheet from vacuum forming device 110.

In the present embodiment, as shown for contact heating device 120 in FIGS. 1 and 2, four heating platen devices 121, 122, 123, and 124 are positioned at substantially equal intervals along the feed direction Ds of the resin composition sheet. Thus, heating platen devices 121, 122, 123, and 124 are chiefly constituted from movable heat platens 121a, 122a, 123a, and 124a, and fixed heat platens 121b, 122b, 123b, and 124b. Furthermore, as shown in FIG. 2, mold-release sheets Tf are attached to the opposing surfaces of movable heat platens 121a, 122a, 123a, and 124a, and fixed heat platens 121b, 122b, 123b, and 124b. Thus, in this contact heating device 120, four movable heat platens 121a, 122a, 123a, and 124a synchronously move towards to fixed heat platens 121b, 122b, 123b, and 124b at predetermined time intervals, Soften by heating the resin composition sheet S in contact with the movable heat platens and fixed heat platens.

Furthermore, in the present embodiment, resin composition sheet S is brought along the feed direction Ds of the resin composition sheet intermittently, only at the intervals corresponding to the two parts of heating platen devices 121, 122, 123, and 124. In other words, in this contact heating device 120, resin composition sheet S is heated twice by heating platen devices 121, 122, 123, and 124.

As shown in FIGS. 1 and 2, vacuum forming device 110 is chiefly constituted from movable mold 111, fixed mold 112, and decompression device 113. Movable mold 111 is equipped with a protruding part (not shown in the Figure), and the protruding parts of movable mold 111 fit into the concave parts (not shown in the Figure) with which fixed mold 112 is equipped. Decompression device 113 is equipped with the lower portion of fixed mold 112, and it is possible to reduce the interior pressure of the concave parts through apertures formed in the walls of the concave parts of fixed mold 112.

Furthermore, in the present embodiment, movable mold 111 moved toward fixed mold 112 synchronously with the movable platens 121a, 122a, 123a, 124a.

The present invention is explained below in further detail using working examples and comparative examples.

### WORKING EXAMPLE 1

1. Preparation of Carrier Tape

(1) Preparation of Pellets

Pellets were prepared from 80 parts by weight of an aromatic polycarbonate resin (E-2000F, Mitsubishi Engineering Plastics), 20 parts by weight of a PCTG amorphous polyester resin (SKYGREEN J2003, SK Chemicals), 10 parts by weight of a carbon black (Ketjen Black EC, Ketjen Black International, DBP absorbed oil content: 360 cm³/100 g; pH: 9.0; volatile content: 0.5 wt %), and 1 part by weight of talcum powder (PK-C, Hayashi Kasei), which was introduced and kneaded into a biaxial extruder with a 45 mm cylinder diameter.

(2) Preparation of Carrier Tape Original Fabric

The pellets obtained as explained above were extruded as a pellet melt while being introduced and kneaded into a monoaxial extruder with a 50 mm diameter cylinder, and while this melt cooled it was taken off using a take-off unit to prepare a sheet with a thickness of 300 μm. Thereafter, this sheet was cut to a predetermined width to give the carrier tape original fabric.

(3) Preparation of Carrier Tape

The abovementioned carrier tape original fabric was fed into the carrier tape manufacturing device shown in the abovementioned FIGS. 1 and 2, to manufacture a carrier tape. Furthermore, to evaluate the molding temperature range for the carrier tape original fabric in the present embodiment,

2. Evaluation of the Molding Temperature Range and the Carrier Tape

(1) Evaluation of Heater Marks

When visual inspection is used to ascertain whether or not there is any transfer of the shape of the mold-release sheet (Teflon® tape) (referred to below as “heater marks”) to the carrier tape obtained as described above, the absence of heater marks on the carrier tape is confirmed (see Table 1).

(2) Evaluation of the Molding Shape

When it is ascertained whether or not the shape of the concave portion of the carrier tape (holding pocket portion) obtained as described above falls within the design specs, the shape of the concave portion of the carrier tape falls within the design specs (see Table 1).

(3) Evaluation of the Molding Temperature Range

In the present working example, as described above, the set temperature of the heating platen of the contact heating device is changed in increments of 5° C. from 200° C. to 250° C. as the carrier tape is manufactured. Thus, no heater marks are applied to the carrier tape, and the molding temperature range is within the set temperature range so that R is 0.3 mm or less for the shape of the corner of the concave portion (holding pocket portion).

Furthermore, the molding temperature range of the carrier tape obtained as described above is 240±5° C. (see Table 1).

(4) Evaluation of the External Appearance

When visual inspection is used to ascertain whether or not the irregularities in the carrier tape (including foam portions) obtained as described above exceed permissible levels, irregularities in the carrier tape that exceed permissible levels are confirmed to be absent (see Table 1).

(5) Evaluation of Flexibility

A flexibility test is conducted repeatedly at 180° with respect to corner portion CP of carrier tape CT (see FIG. 3) obtained as described above, which is compliant if fracture occurs after 5 or more repeats, and is not compliant if fracture occurs at less than 5 repeats.

Furthermore, the carrier tape relating to the present working example was compliant in this evaluation (see Table 1).

### WORKING EXAMPLE 2

With the exception of substituting 2 parts by weight as the blending amount of the talc, this carrier tape was manufactured in the same manner as in Working Example 1, and the molding temperature range and carrier tape were evaluated.

Furthermore, the results of the evaluations are as below (See Table 1).

Heater marks: absent

Molded shape: within design specs

Molding temperature range: 240±10° C.

External appearance: no irregularities

Flexibility: complies

### WORKING EXAMPLE 3

With the exception of substituting 3 parts by weight as the blending amount of the talc, this carrier tape was manufactured in the same manner as in Working Example 1, and the molding temperature range and carrier tape were evaluated.

Furthermore, the results of the evaluations are as below (See Table 1).

Heater marks: absent

Molded shape: within design specs

Molding temperature range: 240±5° C.

External appearance: no irregularities

Flexibility: complies

### WORKING EXAMPLE 4

With the exceptions of substituting 60 parts by weight as the blending amount of the polycarbonate resin, substituting 40 parts by weight as the blending amount of the amorphous polyester resin (PCTG), and substituting 2 parts by weight as the blending amount of the talc, this carrier tape was manufactured in the same manner as in Working Example 1, and the molding temperature range and carrier tape were evaluated.

Furthermore, the results of the evaluations are as below (See Table 1).

Heater marks: absent

Molded shape: within design specs

Molding temperature range: 230-10,+5° C.

External appearance: no irregularities

Flexibility: complies

### WORKING EXAMPLE 5

With the exceptions of substituting 40 parts by weight as the blending amount of the polycarbonate resin, substituting 60 parts by weight as the blending amount of the amorphous polyester resin (PCTG), and substituting 2 parts by weight as the blending amount of the talc, this carrier tape was manufactured in the same manner as in Working Example 1, and the molding temperature range and carrier tape were evaluated.

Furthermore, the results of the evaluations are as below (See Table 1).

Heater marks: absent

Molded shape: within design specs

Molding temperature range: 220±5° C.

External appearance: no irregularities

Flexibility: complies

### WORKING EXAMPLE 6

With the exceptions of substituting 30 parts by weight as the blending amount of the polycarbonate resin, substituting 70 parts by weight as the blending amount of the amorphous polyester resin (PCTG), and substituting 2 parts by weight as the blending amount of the talc, this carrier tape was manufactured in the same manner as in Working Example 1, and the molding temperature range and carrier tape were evaluated.

Furthermore, the results of the evaluations are as below (See Table 1).

Heater marks: absent

Molded shape: within design specs

Molding temperature range: 210±5° C.

External appearance: no irregularities

Flexibility: complies

### WORKING EXAMPLE 7

With the exceptions of substituting 30 parts by weight as the blending amount of the polycarbonate resin, and substituting 70 parts by weight as the blending amount of the amorphous polyester resin (PCTG), this carrier tape was manufactured in the same manner as in Working Example 1, and the molding temperature range and carrier tape were evaluated. Furthermore, the results of the evaluations are as below (See Table 1).

Heater marks: absent

Molded shape: within design specs

Molding temperature range: 210 −0,+5° C.

External appearance: no irregularities

Flexibility: complies

### WORKING EXAMPLE 8

With the exceptions of substituting 30 parts by weight as the blending amount of the polycarbonate resin, substituting 70 parts by weight as the blending amount of the amorphous polyester resin (PCTG), and substituting 3 parts by weight as the blending amount of the talc, this carrier tape was manufactured in the same manner as in Working Example 1, and the molding temperature range and carrier tape were evaluated.

Furthermore, the results of the evaluations are as below (See Table 2).

Heater marks: absent

Molded shape: within design specs

Molding temperature range: 210±5° C.

External appearance: no irregularities

Flexibility: complies

### WORKING EXAMPLE 9

With the exceptions of substituting 90 parts by weight as the blending amount of the polycarbonate resin, substituting 10 parts by weight as the blending amount of the amorphous polyester resin (PCTG), and substituting 2 parts by weight as the blending amount of the talc, this carrier tape was manufactured in the same manner as in Working Example 1, and the molding temperature range and carrier tape were evaluated.

Furthermore, the results of the evaluations are as below (See Table 2).

Heater marks: absent

Molded shape: within design specs

Molding temperature range: 245 −0,+5° C.

External appearance: no irregularities

Flexibility: complies

### WORKING EXAMPLE 10

With the exceptions of the amorphous polyester resin PCTG being replaced with a PETG amorphous polyester resin (SKYGREEN K2012, SK Chemicals), and substituting 2 parts by weight as the blending amount of the talc, this carrier tape was manufactured in the same manner as in Working Example 1, and the molding temperature range and carrier tape were evaluated.

Furthermore, the results of the evaluations are as below (See Table 2).

Heater marks: absent

Molded shape: within design specs

Molding temperature range: 240 −10,+5° C.

External appearance: no irregularities

Flexibility: complies

### WORKING EXAMPLE 11

With the exceptions of substituting 60 parts by weight as the blending amount of the polycarbonate resin, the amorphous polyester resin PCTG being replaced with a PETG amorphous polyester resin (SKYGREEN K2012, SK Chemicals), along with substituting 40 parts by weight as the blending amount of the amorphous polyester resin, and substituting 2 parts by weight as the blending amount of the talc, this carrier tape was manufactured in the same manner as in Working Example 1, and the molding temperature range and carrier tape were evaluated.

Furthermore, the results of the evaluations are as below (See Table 2).

Heater marks: absent

Molded shape: within design specs

Molding temperature range: 230±5° C.

External appearance: no irregularities

Flexibility: complies

### WORKING EXAMPLE 12

With the exceptions of substituting 30 parts by weight as the blending amount of the polycarbonate resin, the amorphous polyester resin PCTG being replaced with a PETG amorphous polyester resin (SKYGREEN K2012, SK Chemicals), along with substituting 70 parts by weight as the blending amount of the amorphous polyester resin, and substituting 2 parts by weight as the blending amount of the talc, this carrier tape was manufactured in the same manner as in Working Example 1, and the molding temperature range and carrier tape were evaluated.

Furthermore, the results of the evaluations are as below (See Table 2).

Heater marks: absent

Molded shape: within design specs

Molding temperature range: 220 −5,+0° C.

External appearance: no irregularities

Flexibility: complies

### WORKING EXAMPLE 13

With the exceptions of substituting 63 parts by weight as the added amount of the polycarbonate resin, substituting 21 parts by weight as the added amount of the amorphous polyester resin (PCTG), replacing 10 parts by weight of carbon black with 11.5 parts by weight of Ensaco 250G carbon black (Timcal; absorbed oil content: 190 cm³/100 g; pH: 8-11; volatile content: max 0.2 wt %), substituting 2 parts by weight as the added amount of the talc, and the further adding 2.5 parts by weight of Tuftec M1913 maleic acid-grafted SEBS (Asahi Kasei Chemicals), this carrier tape was manufactured in the same manner as in Working Example 1, and the molding temperature range and carrier tape were evaluated.

Furthermore, the results of the evaluations are as below (See Table 3).

Heater marks: absent

Molded shape: within design specs

Molding temperature range: 240±10° C.

External appearance: no irregularities

Flexibility: complies

### WORKING EXAMPLE 14

With the exceptions of substituting 63 parts by weight as the added amount of the polycarbonate resin, substituting 21 parts by weight as the added amount of the amorphous polyester resin (PCTG), replacing 10 parts by weight of carbon black with 11.5 parts by weight of Denka Black carbon black (Denki Kagaku Kogyo; absorbed oil content: 160 cm³/100 g; pH: 9-10; volatile content: max 0.16 wt %), substituting 2 parts by weight as the added amount of the talc, and further adding 2.5 parts by weight of Tuftec M1913 maleic acid-grafted SEBS (Asahi Kasei Chemicals), this carrier tape was manufactured in the same manner as in Working Example 1, and the molding temperature range and carrier tape were evaluated.

Furthermore, the results of the evaluations are as below (See Table 3).

Heater marks: absent

Molded shape: within design specs

Molding temperature range: 230±10° C.

External appearance: no irregularities

Flexibility: complies

### COMPARATIVE EXAMPLE 1

With the exception of not blending in any talc, this carrier tape was manufactured in the same manner as in Working Example 1, and the molding temperature range and carrier tape were evaluated.

Furthermore, the results of the evaluations are as below (See Table 4).

Heater marks: present

Molded shape: within design specs

Molding temperature range: absent

External appearance: no irregularities

Flexibility: complies

### COMPARATIVE EXAMPLE 2

With the exceptions of substituting 100 parts by weight as the blending amount of the polycarbonate resin, substituting 0 parts by weight as the blending amount of the amorphous polyester resin (PCTG), and substituting 2 parts by weight as the blending amount of the talc, this carrier tape was manufactured in the same manner as in Working Example 1, and the molding temperature range and carrier tape were evaluated.

Furthermore, the results of the evaluations are as below (See Table 4).

Heater marks: absent

Molded shape: outside design specs

Molding temperature range: absent

External appearance: no irregularities

Flexibility: complies

[Table 1]

[Table 2]

[Table 3]

[Table 4]

[see end of document for tables]

### INDUSTRIAL APPLICABILITY

The resin composition sheet of the present invention, when used in the manufacture of products packaging such as carrier tapes, and the like, along with the possibility of lowering the molding temperature from 260-280° C. to 200-250° C., even when heated to relatively high temperatures using a contact heating device through a mold-releasing film interposed therebetween, has the characteristic that the replication of mold-releasing film features is unlikely to occur, and in particular is useful as an original fabric for product packaging such as in carrier tapes, injection trays, vacuum formed trays, magazines and the like.

TABLE 1

| | | Working | Working | Working | Working | Working | Working | Working |
|---|---|---|---|---|---|---|---|---|
| | | Example 1 | Example 2 | Example 3 | Example 4 | Example 5 | Example 6 | Example 7 |
| Amorphous polyester resin | | PCTG | PCTG | PCTG | PCTG | PCTG | PCTG | PCTG |
| Resin | Polycarbonate resin | 80 | 80 | 80 | 60 | 40 | 30 | 30 |
| composition | (parts by weight) | | | | | | | |
| | Amorphous polyester | 20 | 20 | 20 | 40 | 60 | 70 | 70 |
| | resin (parts by weight) | | | | | | | |
| | Carbon black | 10 | 10 | 10 | 10 | 10 | 10 | 10 |
| | (parts by weight) | | | | | | | |
| | Talc (parts by weight) | 1 | 2 | 3 | 2 | 2 | 2 | 1 |
| Molding temperature (° C.) | | 200-250 | 200-250 | 200-250 | 200-250 | 200-250 | 200-250 | 200-250 |
| Evaluation | Heater marks | Absent | Absent | Absent | Absent | Absent | Absent | Absent |
| results | Molded shape | Within | Within | Within | Within | Within | Within | Within |
| | | design specs | design specs | design specs | design specs | design specs | design specs | design specs |
| | Molding temperature | 240 ± 5 | 240 ± 10 | 240 ± 5 | 230 −10,+5 | 220 ± 5 | 210 ± 5 | 210 −0,+5 |
| | range | | | | | | | |
| | Sheet external | No | No | No | No | No | No | No |
| | appearance | irregularities | irregularities | irregularities | irregularities | irregularities | irregularities | irregularities |
| | Flexibility | Complies | Complies | Complies | Complies | Complies | Complies | Complies |

TABLE 2

| | | Working | Working | Working | Working | Working |
|---|---|---|---|---|---|---|
| | | Example 8 | Example 9 | Example 10 | Example 11 | Example 12 |
| Amorphous polyester resin | | PCTG | PCTG | PETG | PETG | PETG |
| Resin | Polycarbonate resin | 30 | 90 | 80 | 60 | 30 |
| composition | (parts by weight) | | | | | |
| | Amorphous polyester | 70 | 10 | 20 | 40 | 70 |
| | resin (parts by weight) | | | | | |
| | Carbon black | 10 | 10 | 10 | 10 | 10 |
| | (parts by weight) | | | | | |
| | Talc (parts by weight) | 3 | 2 | 2 | 2 | 2 |
| Molding temperature (° C.) | | 200-250 | 200-250 | 200-250 | 200-250 | 200-250 |
| Evaluation | Heater marks | Absent | Absent | Absent | Absent | Absent |
| results | Molded shape | Within | Within | Within | Within | Within |
| | | design specs | design specs | design specs | design specs | design specs |
| | Molding temperature | 210 ± 5 | 245 −0,+5 | 240 −0,+5 | 230 ± 5 | 220 −5,+0 |
| | range | | | | | |
| | Sheet external | No | No | No | No | No |
| | appearance | irregularities | irregularities | irregularities | irregularities | irregularities |
| | Flexibility | Complies | Complies | Complies | Complies | Complies |

TABLE 3

| | | Working | Working |
|---|---|---|---|
| | | Example 13 | Example 14 |
| Amorphous polyester resin | | PCTG | PCTG |
| Resin | Polycarbonate resin (parts by weight) | 63 | 63 |
| composition | Amorphous polyester resin (parts by weight) | 21 | 21 |
| | Carbon black (parts by weight) | 11.5 | 11.5 |
| | Talc (parts by weight) | 2 | 2 |
| | Maleic acid-grafted SEBS (parts by weight) | 2.5 | 2.5 |
| Molding temperature (° C.) | | 200-250 | 200-250 |
| Evaluation | Heater marks | Absent | Absent |
| results | Molded shape | Within design specs | Within design specs |
| | Molding temperature range | 240 ± 10 | 240 ± 10 |
| | Sheet external appearance | No | No |
| | | irregularities | irregularities |
| | Flexibility | Complies | Complies |

TABLE 4

| | | Comparative | Comparative |
|---|---|---|---|
| | | example 1 | example 2 |
| Amorphouse polyester resin | | PCTG | PCTG |
| Resin | Polycarbonate resin (parts by weight) | 80 | 100 |
| composition | Amorphous polyester resin (parts by weight) | 20 | 0 |
| | Carbon black (parts by weight) | 10 | 10 |
| | Talc (parts by weight) | 0 | 2 |
| Molding temperature (° C.) | | 200-250 | 200-250 |
| Evaluation | Heater marks | Present | Absent |
| results | Molded shape | Within design specs | Outside design specs |
| | Molding temperature range | Absent | Absent |
| | Sheet external appearance | No | No |
| | | irregularities | irregularities |
| | Flexibility | Complies | Complies |

1. Resin composition sheet comprising
a polycarbonate resin;
an amorphous polyester resin;
and a silicate compound filler.

2. The resin composition sheet as recited in claim 1,
wherein the silicate compound filler is added as 1 part by weight or more and 3 parts by weight or less when the total amount of the polycarbonate resin and amorphous polyester resin is taken as 100 parts by weight.

3. The resin composition sheet as recited in claim 1,
wherein the polycarbonate resin is added as 30 parts by weight or more and 80 parts by weight or less when the total amount of the polycarbonate resin and amorphous polyester resin is taken as 100 parts by weight.

4. The resin composition sheet as recited in claim 1,
wherein the amorphous polyester resin is composed of at least 1 type of dicarboxylic acid-derived unit selected from the group comprising terephthalic acid-derived units and terephthalic acid derivative-derived units, and of glycol-derived units including-less than 50 mol % of 1,4-cyclohexanedimethanol-derived units.

5. The resin composition sheet as recited in claim 1,
wherein the amorphous polyester resin is composed of at least 1 type of dicarboxylic acid-derived unit selected from the group comprising terephthalic acid-derived units and terephthalic acid derivative-derived units, and of glycol-derived units including 50 mol % or more of 1,4-cyclohexanedimethanol-derived units.

6. The resin composition sheet as recited in claim 1,
wherein the further comprising conductive carbon blacks that has absorbed oil content of 130 cm³/100 g or more, the pH of 8 or higher.

7. The resin composition sheet as recited in claim 6,
wherein the conductive carbon black has a volatile matter content of 0.3 wt % or less.

8. The resin composition sheet as recited in claim 6,
wherein the conductive carbon black is added as 5 parts by weight or more and 25 parts by weight or less when the total amount of the polycarbonate resin and amorphous polyester resin is taken as 100 parts by weight.

9. Method for molding the resin composition sheet comprising claim 1,
a heating step for heating the resin composition sheet via being placed in contact with a heating medium with a mold-releasing film described in claim 1, and
a molding step wherein the resin composition sheet that has been heated in the heating step is molded into a predetermined shape.
